(19) United States
(12) Patent Application Publication
(10) Pub. No.: US 2023/0374900 A1
(43) Pub. Date: Nov. 23, 2023

(54) Characterization and Geomodeling of Three-Dimensional Vugular Pore System in Carbonate Reservoir

(71) Applicant: Saudi Arabian Oil Company, Dhahran (SA)

(72) Inventor: Adam Danur Zeiza, Dhahran (SA)

(21) Appl. No.: 17/748,660

(22) Filed: May 19, 2022

(51) Int. Cl. E21B 47/04; E21B 49/08; E21B 25/00

(52) U.S. Cl. CPC E21B 47/04; E21B 49/087; E21B 25/005

(57) ABSTRACT

Computer-implemented methods, media, and systems for characterization and geomodeling of three-dimensional (3D) vugular pore system (VPS) in carbonate reservoir are disclosed. One example method includes determining an occurrence of a VPS in multiple layers of a carbonate reservoir based on data collected from multiple wells in the carbonate reservoir. A spatial distribution of multiple VPS intensity classes of the VPS is determined using at least one of well log data, borehole image log data, production log data, or seismic acoustic impedance data from the multiple wells. A 3D VPS intensity distribution model of the VPS is constructed using the spatial distribution of the multiple VPS intensity classes of the VPS. The 3D VPS intensity distribution model is provided for at least one of reservoir volumetric estimation, reservoir history matching, or reservoir quality prediction of the carbonate reservoir.

### TECHNICAL FIELD

The present disclosure relates to computer-implemented methods, media, and systems for characterization and geomodeling of three-dimensional (3D) vugular pore system (VPS) in carbonate reservoir.

### BACKGROUND

Carbonate reservoirs can be prone to diagenetic alterations that are chemical processes that can lead to changes in a sediment after its deposition but before its final conversion to rock, particularly dissolutions of unstable or meta-stable carbonate minerals that occur post-deposition. Meta-stable carbonate minerals can transform to another state over a period of time. Dissolution processes can generate vugular pore system (VPS) that has higher secondary porosity and permeability than its associated rock matrix. These VPS related properties are components in both static (3D geocellular) and dynamic (3D reservoir simulation) models, and are input for single-porosity single-permeability, dual-porosity dual permeability, or multi-continuum carbonate reservoir models.

Many carbonate oil and gas fields experience resource and reserve volumes under-estimation, inaccurate history matching, or inaccurate production forecast due to the lack of VPS characterization and integrated 3D VPS property modeling. This under-represented characterization can lead to inadequate reservoir management and business development decisions.

### SUMMARY

The present disclosure provides computer-implemented methods, media, and systems for characterization and geomodeling of three-dimensional (3D) vugular pore system (VPS) in carbonate reservoir. One example method includes determining an occurrence of a VPS in multiple layers of a carbonate reservoir based on data collected from multiple wells in the carbonate reservoir. A spatial distribution of multiple VPS intensity classes of the VPS across multiple layers of the carbonate reservoir is determined using at least one of well log data, borehole image log data, production log data, or seismic acoustic impedance data from the multiple wells, where each of the multiple VPS intensity classes includes a respective vugular pore size within a respective depth interval of a respective well of the multiple wells, and each of the multiple VPS intensity classes corresponds to a respective fluid flow rate of one or more fluid flow rates of the respective well. A 3D VPS intensity distribution model of the VPS is constructed using the spatial distribution of the multiple VPS intensity classes of the VPS across the multiple layers of the carbonate reservoir. The 3D VPS intensity distribution model is provided for at least one of reservoir volumetric estimation, reservoir history matching, or reservoir quality prediction of the carbonate reservoir.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a schematic illustration of an example workflow for three-dimensional carbonate vugular pore system characterization and geomodeling, in accordance with example implementations of this disclosure.

FIG. 2 illustrates an example of a VPS log, in accordance with example implementations of this disclosure.

FIG. 3 illustrates an example of multiple logs, in accordance with example implementations of this disclosure.

FIG. 4 illustrates an example of the cross-plot of porosity, acoustic impedance, and VPS intensity class, in accordance with example implementations of this disclosure.

FIG. 5 illustrates an example of vertical proportion curves of the VPS intensity classes in each 3D model zone, in accordance with example implementations of this disclosure.

FIG. 6 illustrates an example of an experimental variogram of a VPS intensity class, in accordance with example implementations of this disclosure.

FIG. 7 illustrates an example of 20 degree azimuth at a major direction and 290 degree azimuth at a minor direction, in accordance with example implementations of this disclosure.

FIG. 8 illustrates an example of integrated 3D VPS geomodeling, in accordance with example implementations of this disclosure.

FIG. 9 is a flowchart illustrating an example method for three-dimensional carbonate vugular pore system characterization and geomodeling, in accordance with example implementations of this disclosure.

FIG. 10 is a schematic illustration of example computer system that can be used to execute implementations of the present disclosure.

### DETAILED DESCRIPTION

The architecture of VPS and its associated properties in a reservoir, such as porosity, permeability and water saturation, can provide reservoir heterogeneity, extra hydrocarbon pore-volume, and higher permeability that are used to construct the 3D geologic and reservoir simulation models, estimate volumes, support history matching, guide reservoir management, and generate accurate reservoir quality and production prediction, as more detailed modeling of reservoir heterogeneity, hydrocarbon pore-volume, and permeability by considering the occurrence of VPS in the reservoir can provide more accurate modeling of the reservoir for the purpose of reservoir volume estimation, reservoir history matching, reservoir management, and reservoir quality and production prediction.

This disclosure describes technologies for three-dimensional carbonate vugular pore system characterization and geomodeling. In some implementations, a workflow can integrate static (geoscience) and dynamic (reservoir engineering) datasets and analyses, such as petrographic thin section analyses, facies core descriptions, wireline-logs interpretation, borehole image logs interpretation, production logging tool (PLT) flow meter integration, diagenetic proxies and concepts integration, 3D seismic attribute geobody detection and 3D geo-cellular property modeling. Petrographic thin section analysis can provide a detailed description of the texture, sedimentary structures, grain composition, and types and distribution of macroporosity seen in a thin section. Facies core description can provide information of coral-rich facies using core data. Wireline logs can provide measurements of borehole formation properties such as electrical and sonic properties, as well as formation pressure measurement. Borehole image logs can provide centimeter-scale images of the borehole wall and the rocks that make it up. PLT flow meter can provide measurements of axial velocity of fluid flow in a borehole. Diagenetic proxies and concepts can describe changes in a sediment after its deposition and before its final conversion to rock. 3D seismic attribute geobody can be used to represent seismic features such as 3D seismic acoustic impedance cube. 3D geo-cellular properties can include porosity, permeability, and water saturation of a reservoir. The characterization and geomodeling of VPS can be used to improve up-side volumetric estimation, history-matching and reservoir quality prediction.

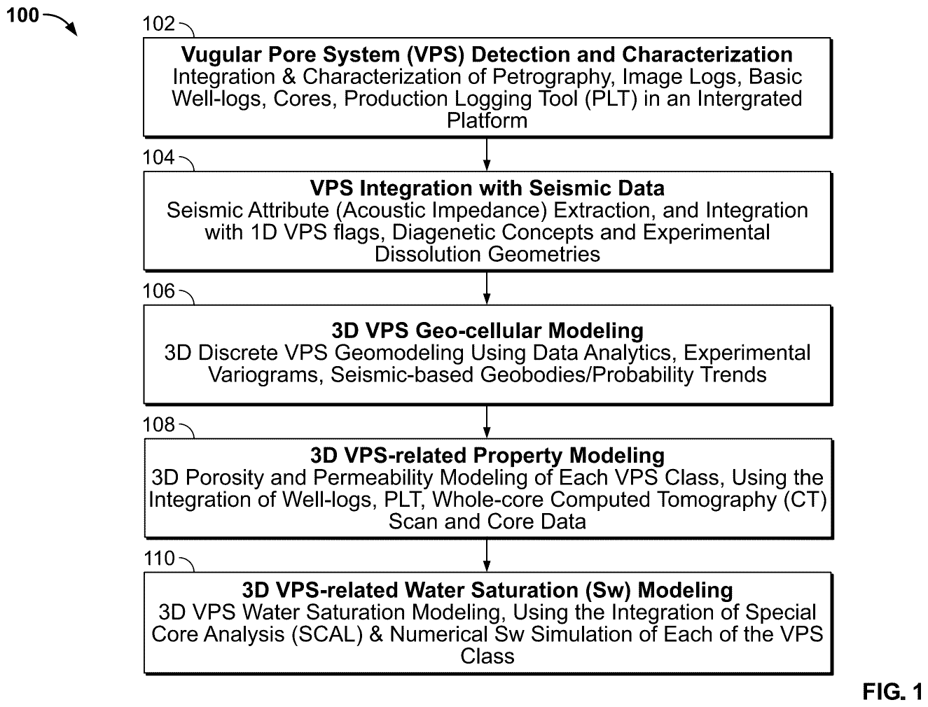

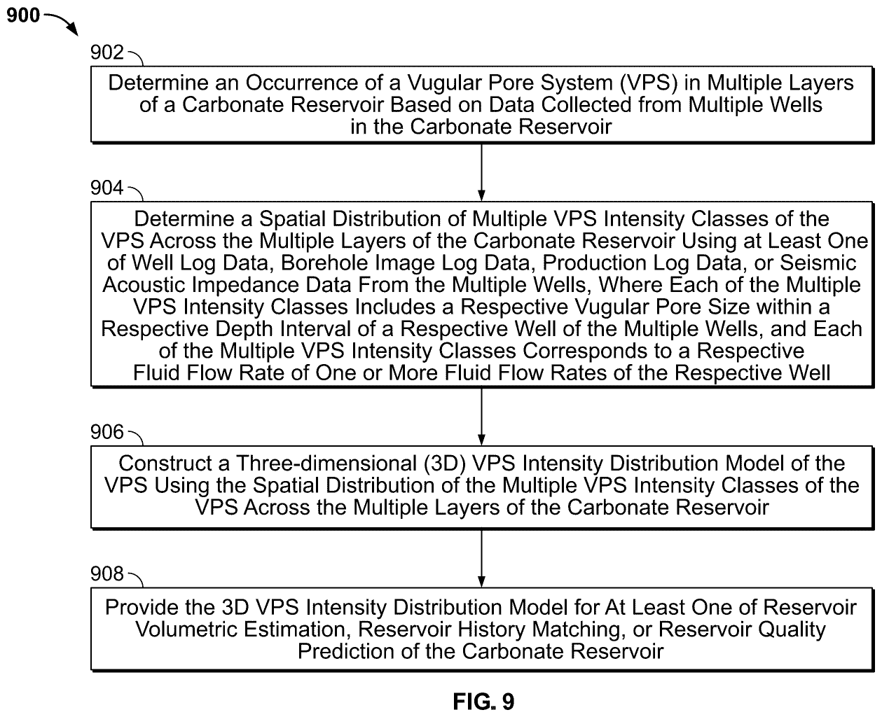

FIG. 1 is a schematic illustration of an example workflow 100 for three-dimensional carbonate vugular pore system characterization and geomodeling, in accordance with example implementations of this disclosure. The example workflow 100 can be implemented by the computer system described in FIG. 9.

At 102, detection and characterization of VPS in a reservoir is performed, where one-dimensional (1D) data from each well in the reservoir are used to detect and characterize the occurrence of the VPS. In some implementations, VPS is a pore system in carbonate rocks (reservoirs) that is derived from post-depositional dissolution processes. VPS has pore shape and geometries that are termed in carbonate geology (sedimentology) as “vuggy pores” or “vugular pores”. These vugular pore shape and geometries are different than the depositional-related pores, which are normally inter-granular and more uniform in shape and size. Individual vugular pore size can span from millimeters to centimeters. The combination of smaller vugular pores may form meter-scale vugular zones, which are termed VPS in this disclosure. In some examples, several individual vugular pore systems may further be dissolved to form meter-scale cavities.

In some implementations, the 1D data include data such as wire-line logs, (e.g., gamma ray log and density log from a gamma ray based logging device, neutron log, total porosity log, and limestone-dolomite multi-mineral log from a neutron based logging device, caliper log from a multifinger caliper, nuclear magnetic resonance (NMR) log and total porosity log from an NMR scanner), core litho-facies description flags from core descriptions, borehole formation image logs from a formation microscanner, cumulative oil production flow logs and flow rate logs from a flowmeter, and 1D seismic acoustic impedance logs based on data from density log and data from an acoustic logging device.

In some implementations, vugular-shaped or cavernous conductive features in the borehole image log can be detected as intervals of VPS. The borehole image data can be used to define the shape (geometry) of the vugs or cavernous features. The borehole image data can also provide VPS height and length within the penetrated borehole. These information can be used to estimate the shape (geometry) of the vugs or cavernous features. More specifically, the cavernous features occur as dark (conductive) features (zones) in the image logs and they can span several meters in height. To detect vugular-shaped or cavernous features, first the borehole image log can be displayed along with other well-logs such as caliper, density, neutron, production flow meter logs. Next zones in the borehole image log with more conductive (darker) signals are defined. These zones are the potential vugular or cavernous feature intervals. Vugular shape features can occur as ramified (vuggy pore) geometries. Large cavity can show a complete conductive (darker) zone in a particular image log interval. The potential vugular or cavernous feature intervals are then compared with other logs such as caliper, density, neutron and production flow meter logs. For example, large cavity features can correspond to elevated caliper log values, lower density log values, higher neutron log values, and highly elevated fluid flow rate in the production flow meter log. If these corresponding criteria match each other at a particular depth interval in a well, then this interval can be detected as an interval of VPS given the detected vugular or cavernous features associated with this interval.

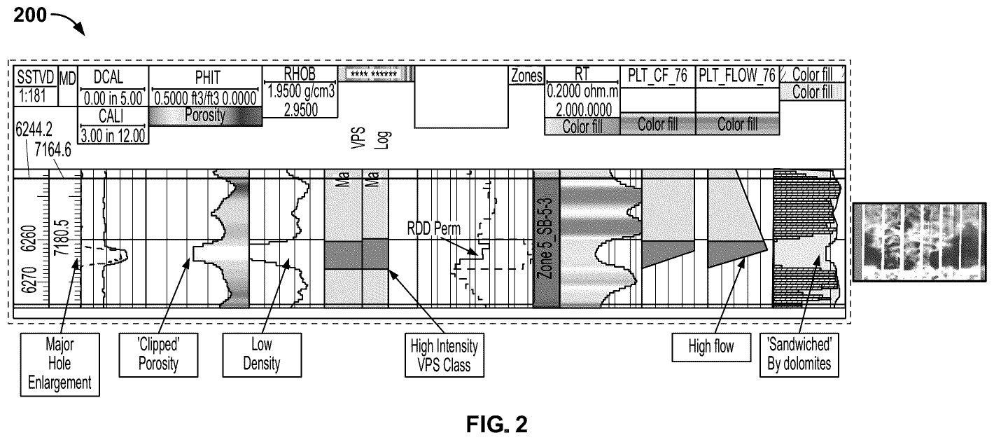

In some implementations, borehole enlargement, which is shown by caliper or delta caliper (DCAL) logs, can be used for VPS detection. Caliper logs can provide a continuous size of a borehole along its depth. Borehole size can remain nearly constant across a borehole interval. When there is a borehole enlargement due to vugular or cavernous features, a borehole interval can have a larger borehole size as shown by the example caliper log in FIG. 2. This enlargement can also be shown by the DCAL logs that measure differences between borehole size at a certain depth and a baseline borehole size in an interval (a range of depth). Higher caliper and DCAL values can indicate borehole enlargement, which can suggest the occurrence of VPS. This information can be cross-checked against other logs such as the borehole image logs and density logs to confirm the VPS occurrence. More specifically, borehole enlargement from caliper log can be used to cross check the occurrence of VPS that is observed in a borehole image log. Borehole enlargement from caliper log acts as a supporting factor to indicate the occurrence of VPS, along with other logs such as the borehole image log, density, neutron as well as information from petrographic thin sections in a specific depth interval. These inter-related factors can be observed well-by-well by integrating and displaying the logs (e.g. borehole image, caliper, density and neutron logs) in an integrated 1D well section window.

In some implementations, slightly-elevated (>300 STB/Day), moderately elevated (>500 STB/Day) or highly elevated (>1000 STB/Day) fluid flow rates can be shown in the production flow meter logs. These fluid flow rates respectively relate to the VPS size and intensity (i.e. VPS intensity classes). VPS intensity represents vugular pore size and abundance within a specific depth interval in a well. It can be observed from borehole image logs by observing both size and abundance of the vugular pores. VPS intensity class represents distinct vugular pore size and abundance within an interval that corresponds to certain fluid flow rates. VPS intensity class can be converted into discrete logs (flags) to represent different levels of detected VPS intensities. More specifically, the VPS intensity classes are defined as discrete logs and are represented by integers, where an individual integer represents a group with similar VPS criteria (intensities).

In some implementations, well-by-well VPS cross validations between different parameters such as production flow meter, caliper, borehole image, and density logs can be performed to define the relationship between VPS intensity classes and the fluid flow rates. Higher intensity VPS classes can correspond to higher fluid flow rates, whereas lower intensity VPS classes can correspond to lower fluid flow rates. More specifically, the cross validations can be performed by integrating and displaying the aforementioned logs in an integrated 1D well section window, cross-checking whether the respective parameters, such as the flow rates from the PLT and the vugular pore intensities seen in borehole image log, are consistent. If all the parameters consistently occur in a particular depth interval, a VPS flag is defined as a discrete log for that particular depth interval.

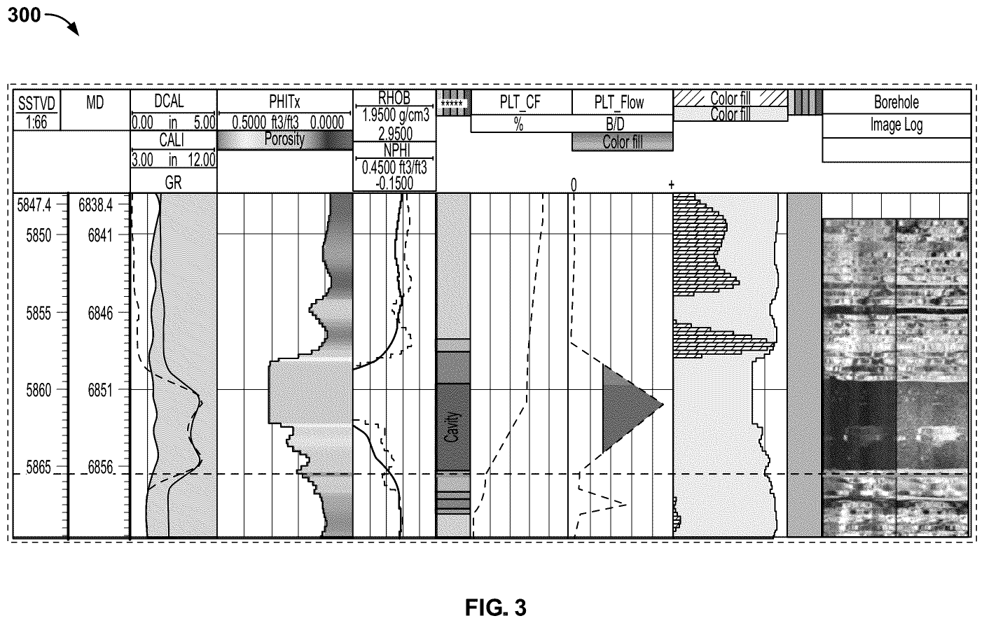

In some implementations, larger-scale higher intensity vugular network can show a higher total porosity (>±30%). Cavity can show clipped-log porosity and very low density, and is bounded by overlying and underlying Dolomite beds as shown by multi-mineral and resistivity logs. The porosity logs (including clipped-log porosity) can be displayed along with other logs such as the caliper, density and borehole image logs in an integrated 1D well section window. Parameters in these logs are checked across the interval of interest on a well-by-well basis. This integration can allow the detection of larger-scale higher intensity vugular network or cavity. For example, FIG. 3 shows an example where key logs such as caliper, total porosity (PHIT) log, density (RHOB), neutron (NPHI), production logging tool (PLT) flow meter, and borehole image logs are integrated into a well display. Larger-scale higher intensity VPS or cavity can be detected based on several criteria, for example, a conductive (darker) zone in the borehole image log that is continuous across an interval, elevated caliper log values that are at least two inches larger than the baseline borehole diameter, clipped PHIT log value that are in the higher porosity end, density (RHOB) log value that is lower than 1.95g/cm³, neutron (NPHI) value that is higher than 0.45 pu, and highly elevated (>1000 STB/Day) fluid flow rates observed in the PLT log. As shown in FIG. 3, the clipped log porosity values can be observed, as they are indicated by a flat (constant) porosity values that stand out in between other continuous porosity values by depth. Within a cavity zone or high intensity vugular network zone, density log can be lower than 1.95 g/cm³.

In some implementations, portions of the VPS correspond to coral-rich facies such as the Cladocoropsis and Stromatoporoid-coral facies and their associated facies assemblages that occur within certain zones. Coral-rich facies such as the Cladocoropsis and Stromatoporoid-coral facies can be described from core data. The core descriptions can be represented using facies codes (flags) in order for the facies to be displayed visually and assigned into numerical values (codes). These numerical values are integers where an individual integer represents a group with similar facies criteria. The facies flags can then be incorporated into the 1D well-section display along with other logs, including the VPS intensity class flag. Statistical extractions and plots can be made between different parameters, including between the facies and VPS intensity class flags.

In some implementations, petrographic thin-sections in the VPS intervals can show dissolution-related microscopic features such as moldic, enlarged inter-granular, touching-vugs, or dissolved dolomite pores. These features can be observed through petrographic (microscopic) thin section analyses. These dissolution-related microscopic features are then represented using codes (flags) in order for them to be displayed visually and assigned into numerical values (codes). These numerical values are integers where an individual integer represents a group with similar VPS criteria (intensities). Statistical extractions and plots can be made between different parameters, including between the dissolution-related microscopic features and VPS intensity class flags.

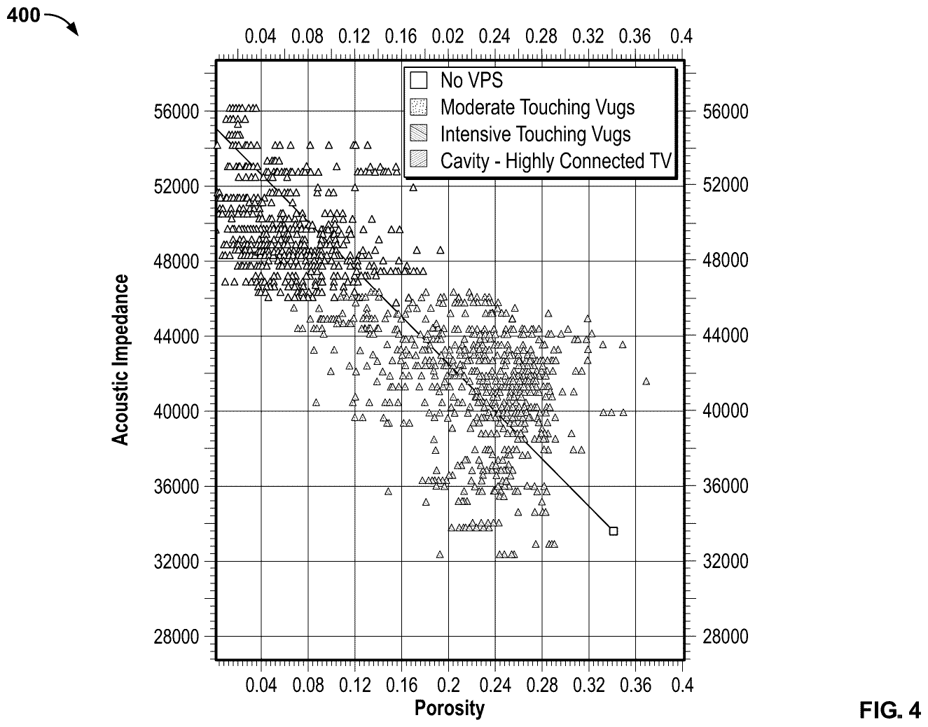

In some implementations, the majority of the VPS intensity class flags occur within a lower seismic acoustic impedance (approximately <45,000 ft/sec*g/cm³) and higher seismic amplitude geobodies. The VPS features (i.e. VPS intensity class flags) can be compiled into discrete logs. At a later stage these discrete logs can be improved into continuous VPS intensity logs. The higher amplitude ranges can be estimated based on a cross-plot of porosity, quadrature seismic amplitude, and VPS intensity class flag. An example of the cross-plot is shown in FIG. 4. The lower amplitude ranges that do not correspond to the VPS intensity class flags can be filtered out. This process can keep the higher amplitude geobodies that correspond to the VPS.

At 104, the 1D VPS intensity class flags generated at 102 are integrated with seismic data. In some implementations, after the 1D VPS detection and characterization are completed, the 1D VPS intensity class flags are associated with seismic attributes, such as the seismic acoustic impedance, in order to guide the spatial VPS intensity distribution modeling. The 3D seismic acoustic impedance cube is extracted into VPS probability (i.e. lower impedance) geobodies, by filtering out higher acoustic impedance and extracting the lower acoustic impedance signals to represent areas with higher probability of VPS occurrence. The 1D VPS intensity class flags are also associated with carbonate diagenesis concepts and experimental carbonate dissolution geometries. More specifically, the carbonate diagenesis concepts can help define the controlling factors of the post-depositional diagenesis (dissolution) that generates the VPS. These controlling factors, in-turn, can help delineate the gross distribution of the VPS within the field. For example, late burial diagenetic dissolutions can be a major controlling factor of the VPS formation. Therefore higher dissolution can be within the proximity of crestal area of the field, and the VPS can occur within the crestal area of the field. Experimental carbonate dissolution geometries can be used as analog to defining the shape and geometry of the VPS distribution model within 3D space. For example, carbonate dissolution experiments can show ramified patterns along areas that are dissolved by dissolution media. This information can then be used to define the 3D property modeling algorithm that can represent the shape and geometry of the 3D VPS geobodies.

In some implementations, to show the correlation between the acoustic impedance and the VPS intensity class, cross-plot of porosity (X-axis), acoustic impedance (Y-axis) and VPS intensity class (Z-axis) can be generated. FIG. 4 illustrates an example 400 of the cross-plot of porosity, acoustic impedance, and VPS intensity class. It can be observed from FIG. 4 that VPS intensity class flags correspond to lower acoustic impedance values.

In some implementations, to filter out higher acoustic impedance values that does not correspond to the VPS intensity class flags, a threshold can be set. For example, acoustic impedance values above 45,000 ft/sec*g/cm³ can be filtered out, and acoustic impedance values below 45,000 ft/sec*g/cm³ are kept.

At 106, a 3D VPS geo-cellular model, for example, a 3D VPS intensity distribution model, is constructed using data analytics, experimental variograms, and seismic-based geobodies and probability trends.

In some implementations, the first step in the data analytics is to set the vertical proportion of each VPS intensity class in each 3D model zone. The vertical proportion represents the percentage of each VPS intensity class distribution in the vertical direction and provides the basis for distributing the 3D VPS intensity distribution model in the vertical direction. Each 3D model zone represents a distinctive layer in the 3D geo-cellular (reservoir) model and is bounded by two geological surfaces at the top and bottom of the 3D model zone, respectively.

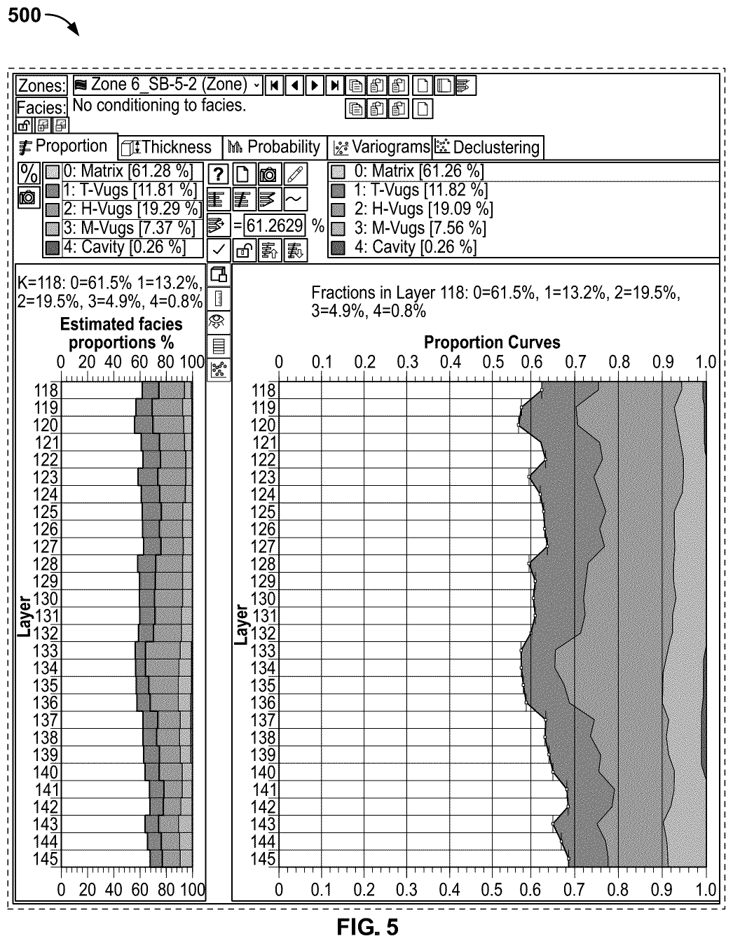

In some implementations, to set the vertical proportion, first each VPS intensity class is assigned into the 3D geo-cellular cells of the 3D geo-cellular model. Then all of the assigned VPS intensity classes are used to generate the vertical proportions. FIG. 5 illustrates an example 500 of vertical proportion curves of the VPS intensity classes in each 3D model zone. These proportion curves are displayed as estimated VPS proportions (%) in the X axis and geo-model layer numbers in the Y axis.

In some implementations, subsequent data analytic processes are to analyze the spatial distribution of the VPS intensity classes, using experimental variogram analysis. More specifically, the azimuth and major and minor variogram ranges are experimentally estimated by VPS intensity class and by 3D model zone, and are used as the first order control of the VPS intensity distribution ranges. These sets of data analytic parameters can delineate the first-order geometry of the VPS geobodies.

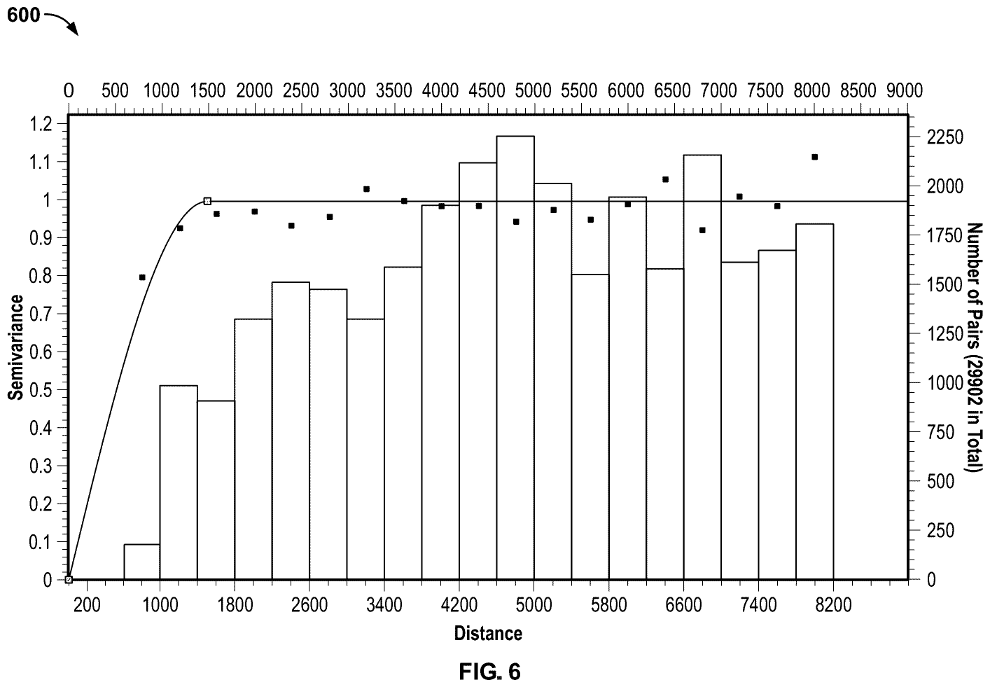

In some implementations, to analyze the spatial distribution of the VPS intensity classes, the VPS intensity class data points are plotted into ‘Distance’ in X axis (i.e. distance between data points spatially) and ‘Semivariance’ (i.e. degree of data variability between data points). VPS intensity class major and minor variogram ranges are estimated from a distance when the data-points level off in a certain major and minor direction, respectively. FIG. 6 is an example 600 of an experimental variogram of a VPS intensity class. The X-axis represents the distance between pairs of VPS intensity class data points, and the Y-axis represents the Semivariance. The points represent VPS experimental variogram points. The curve represents variogram model. The histogram represents the number of pairs of VPS intensity class data points in a specific distance.

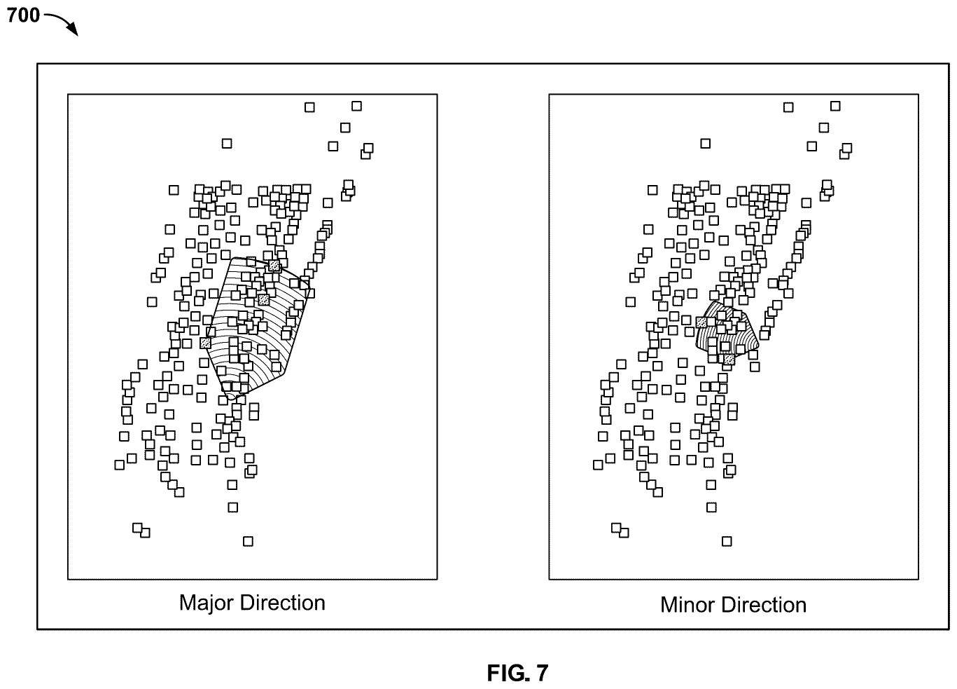

In some implementations, VPS intensity class major direction represents a major orientation of data correlation, which corresponds to longer variogram ranges, whereas minor direction represents a minor orientation of data correlation, which corresponds to shorter variogram ranges. Adjustment of the variogram analyses are also performed by adjusting and estimating the azimuth (angle) of data correlation. FIG. 7 is an example 700 of 20 degree azimuth at a major direction and 290 degree azimuth at a minor direction.

In some implementations, all data analytic results from the aforementioned steps are then applied into a geostatistical process in a 3D geomodeling software platform to populate geological facies (discrete property) in a 3D domain, in order to generate the final 3D VPS intensity distribution model.

In some implementations, another input used in the geostatistical process is the seismic acoustic impedance-based geobodies. The seismic acoustic impedance-based geobodies are computed as a numeric trend map as a representation of the VPS occurrence. More specifically, the 3D seismic acoustic impedance is extracted into continuous numerical values that represent the probable VPS distribution. This extraction is done by filtering out higher seismic acoustic impedance values and averaging the lower seismic acoustic impedance values within the zone of interest. For example, acoustic impedance values above 45,000 ft/sec*g/cm³ can be filtered out, and acoustic impedance values below 45,000 ft/sec*g/cm³ are kept. This input of seismic acoustic impedance-based geobodies is embedded as secondary (soft) probability trend spatially, for example, along the I- and J-column of the 3D geo-cellular model grids, to guide the occurrence of VPS beyond well controls.

In some implementations, once the final 3D VPS intensity distribution model is completed, the next steps in the integrated workflow are to populate the 3D VPS intensity distribution model with VPS-related properties such as porosity, permeability and water saturation, as described below.

At 108, 3D VPS-related property models, such as a 3D VPS porosity model and a 3D VPS permeability model, are constructed during the integrated workflow.

In some implementations, a 3D VPS porosity model can be constructed by integrating porosity values derived from whole-core computed tomography (CT) scans, borehole image logs, nuclear magnetic resonance (NMR) logs, and numerical simulations. Porosity histograms and ranges generated from the integration of aforementioned datasets can then be used as input for the 3D porosity modeling.

In some implementations, CT scan can be used to determine the volume of porosity on whole core by using the stacking or slices made by the CT scanner to produce a tomogram of samples from which the porosity can be estimated.

In some implementations, borehole image logs have the resolution of a few millimeters and can be used to estimate vugular porosity when vugular porosity is beyond the realm of whole core. Some reservoir rocks exhibit porosities that cannot be captured by core. In such cases borehole image logs can be analyzed and used to calculate the porosity as a function of contrast observed on the images.

In some implementations, NMR logs can provide measurements of porosity by inducing in the fluids within porosity of the rock a magnetic spin. These measurements can be converted to a porosity spectrum using a term called T2. The NMR measurements can be related to an upper limitation to the size of pores (vugs) and this limitation allows for the identification of zones that have porosity larger than what the NMR tool can physically measure. These NMR measurements of this deficit in porosity can be used in high grade zones with very large vugs.

In some implementations, a method that utilizes Kriging mean and variance to generate a Gaussian distribution can be used to get multi-realizations of the normal Gaussian distribution of the VPS porosity when generating the 3D VPS porosity model, based on porosity histograms and ranges generated from the integration of aforementioned datasets.

In some implementations, a 3D VPS permeability model can be constructed by integrating permeability values derived from production logging tool (PLT), well tests, whole-core CT scans, and core data. These data can be used to generate the porosity to permeability transform of each VPS intensity class. The transforms are in-turn used to generate the 3D VPS permeability model by utilizing methods such as cloud-transform method. In some implementations, a permeability height map and average permeability map are computed after the 3D VPS permeability model is generated. These values are then compared both spatially and in a cross-plot to the well-test based permeability height and average permeability respectively for consistency.

In some implementations, PLT data provide an estimation of permeability using Darcy's equation, by calculating flow-rate contributions, fluid viscosity, pressure and well drainage radius at the hydrocarbon intervals.

In some implementations, well tests such as pressure-transient test can provide permeability estimation by integrating and calculating parameters such as reservoir thickness, fluid viscosity, skin factor, initial reservoir pressure, flowing time, and shut-in time, by utilizing the Darcy's equation.

In some implementations, whole-core CT scan can be used to estimate the permeability on whole core by using the stacking or slices made by the CT scanner to produce a tomogram of samples from which the permeability can be estimated.

In some implementations, the aforementioned analyses are conducted well-by-well, in specific depth ranges.

In some implementations, once permeability values are calculated and measured in each VPS intensity class, they can be plotted against porosity values from equivalent wells and depth ranges, in a form of porosity to permeability cross-plots (clouds). The porosity to permeability cross-plots (clouds) can be further classified by the VPS intensity class in-order to observe the porosity to permeability relation in each of the VPS intensity class. Porosity to permeability transform functions can be generated based on the porosity to permeability cross-plots (clouds) in each VPS intensity class.

In some implementations, once the porosity to permeability transform functions in each of the VPS intensity class are generated, the transform functions can be used to calculate permeability in each VPS intensity class.

In some implementations, the 3D geo-model cells in the 3D VPS permeability model are populated with VPS intensity classes and porosity properties prior to the calculation of VPS permeability values at the 3D geo-model cells. The VPS permeability value in each 3D geo-model cell can be calculated based on the porosity values in the corresponding 3D geo-model cell, using the porosity-to-permeability transform functions.

In some implementations, once the 3D VPS permeability model is generated, a calculation step is performed to generate a permeability height map and an average permeability map, respectively. A permeability height map can be generated by the summation across all geo-model cells of the product of permeability and each geo-model cell height in a reservoir interval, i.e., Perm Height=Σ(permeability value in each cell×geo-model cell height). An average permeability map can be generated by the summation across all geo-model cells of the product of permeability and geo-model cell height divided by the summation of geo-model cell height in a reservoir interval, i.e., Perm Height=Σ(permeability value in each cell×geo-model cell height)/Σgeo-model cell height.

At 110, 3D VPS water saturation (Sw) model is constructed by integrating special core analysis (SCAL) data of the vugular pore samples of the VPS and numerical Sw simulation of the depth intervals of the VPS. These data are used to generate Sw to capillary pressure (Pc) functions of each of the VPS intensity class. Each of the Sw-Pc functions is associated with the VPS intensity classes to generate the final 3D VPS Sw model.

In some implementations, 3D VPS Sw model is constructed by first using a Pc-based function to model rock matrix related components, and then by using zero Pc functions to model the non-Pc (i.e. non-matrix) components corresponding to the vugular pore-space of the VPS, as described below.

In some implementations, vugular porosity can span the boundary between Pc-based function and zero Pc functions. Laboratory Pc procedures can be used for the Pc-based function and these procedures can include mercury injection capillary pressure (MICP), porous plate and centrifuge, and numerical modelling of CT scanned plugs. Special core analysis can provide parameters such as Sw and Pc of rock samples, including samples with VPS.

In some implementations, the VPS can be large enough so that it no longer behaves in the realm of capillarity and therefore are modeled using zero Pc behavior. Zero Pc curves are taken from the SCAL data set that includes data corresponding to the lowest water saturations that are found from SCAL derived from cores taken with oil based mud (OBM) at the start of the fields' life. As the definition of initial water saturation does not hold for zero Pc behavior, non-matrix VPS sections of the core can be oil wet given the large volumes of porosity which are attributed to VPS zones in a zero Pc environment (governed by buoyancy).

In some implementations, Sw and Pc data in each of the VPS intensity class are plotted into Sw-Pc cross-plot. Sw-Pc functions are generated by computing the correlation between Sw and Pc in each of the VPS intensity class. These Sw-Pc functions can in turn be used to calculate Sw model in the 3D domain.

In some implementations, prior to computing the final 3D Sw model, each geo-model cell has been assigned with a VPS intensity class and a Pc value. The Sw calculations for the final 3D Sw model are then conducted in each 3D geo-model cell that has been assigned with a VPS class.

In some implementations, final Sw calculations can utilize calculated Sw-Pc functions in order to populate the Sw values in each geo-model cell of the final 3D Sw model.

In some implementations, all geo-model cells of the final 3D Sw model can be visited and calculated using the Sw-Pc functions and the VPS intensity classes in order to generate the final 3D SW model.

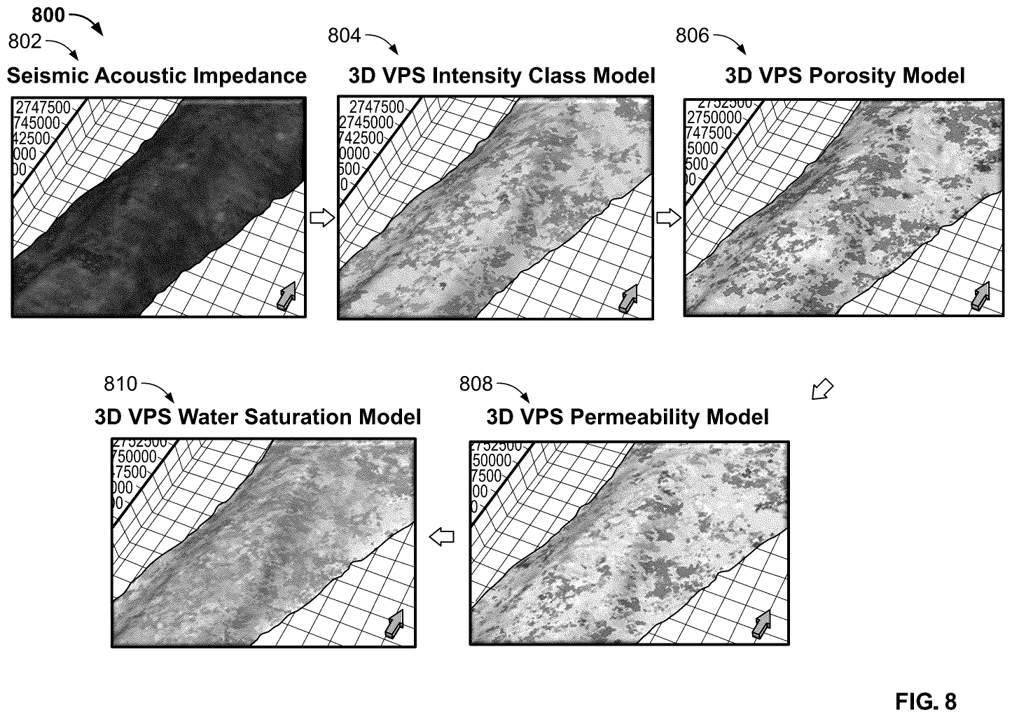

FIG. 8 illustrates an example 800 of integrated 3D VPS geomodeling that uses the example method 100 illustrated in FIG. 1. In FIG. 7, 3D VPS porosity model 806, 3D VPS permeability model 808, and 3D VPS water saturation model 810 are generated after 3D VPS intensity class model 804 is generated based on seismic acoustic impedance 802.

FIG. 9 is a flowchart illustrating an example method 800 for three-dimensional carbonate vugular pore system characterization and geomodeling, in accordance with example implementations of this disclosure.

At 902, a computer system determines an occurrence of a vugular pore system (VPS) in multiple layers of a carbonate reservoir based on data collected from multiple wells in the carbonate reservoir.

At 904, the computer system determines a spatial distribution of multiple VPS intensity classes of the VPS across the multiple layers of the carbonate reservoir using at least one of well log data, borehole image log data, production log data, or seismic acoustic impedance data from the multiple wells, where each of the multiple VPS intensity classes includes a respective vugular pore size within a respective depth interval of a respective well of the multiple wells, and each of the multiple VPS intensity classes corresponds to a respective fluid flow rate of one or more fluid flow rates of the respective well. In some implementations, well log data are data acquired by lowering geophysical logging tools, for example, electric resistivity, gamma-ray based density, neutron or caliper tools, into a well borehole and measuring physical rock properties of the geologic formation by depth. These well log data can be incorporated as logs and displayed on a well-by-well basis in a well section window. Example well log data used for the VPS detection and modeling include density, neutron, porosity, resistivity, and caliper logs. These well-log data can be used for 1D VPS flag detection in multiple wells. Subsequently the detected 1D VPS flags can be used to determine a spatial distribution of multiple VPS intensity classes across the multiple layers of the carbonate reservoir.

At 906, the computer system constructs a three-dimensional (3D) VPS intensity distribution model of the VPS using the spatial distribution of the multiple VPS intensity classes of the VPS across the multiple layers of the carbonate reservoir.

At 908, the computer system provides the 3D VPS intensity distribution model for at least one of reservoir volumetric estimation, reservoir history matching, or reservoir quality prediction of the carbonate reservoir.

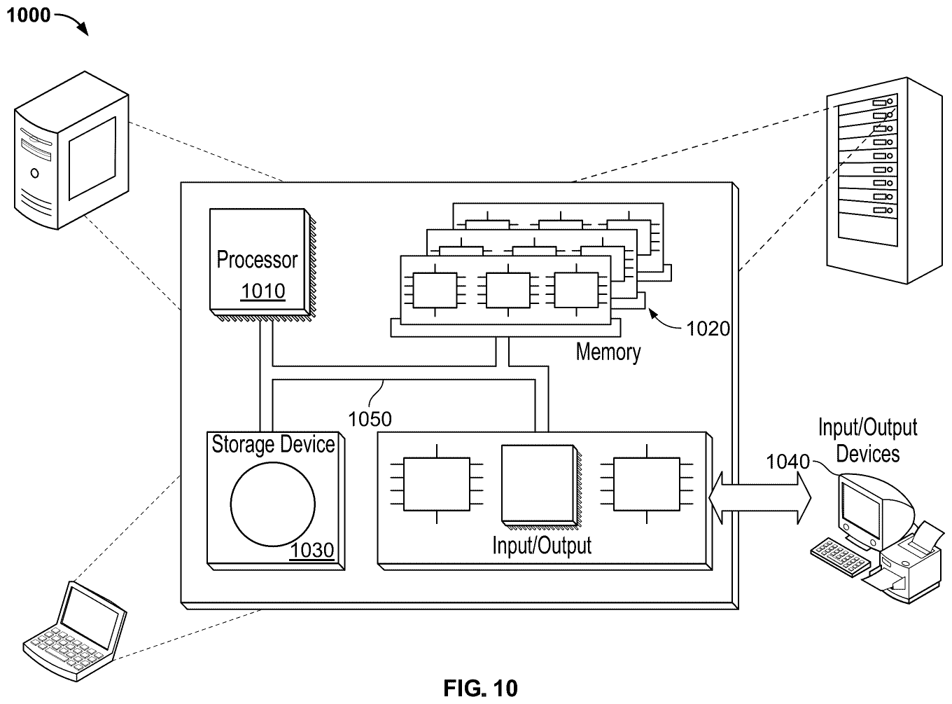

FIG. 10 illustrates a schematic diagram of an example computing system 1000. The system 1000 can be used for the operations described in association with the implementations described herein. For example, the system 1000 may be included in any or all of the server components discussed herein. The system 1000 includes a processor 1010, a memory 1020, a storage device 1030, and an input/output device 1040. The components 1010, 1020, 1030, and 1040 are interconnected using a system bus 1050. The processor 1010 is capable of processing instructions for execution within the system 1000. In some implementations, the processor 1010 is a single-threaded processor. The processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In some implementations, the memory 1020 is a computer-readable medium. The memory 1020 is a volatile memory unit. The memory 1020 is a non-volatile memory unit. The storage device 1030 is capable of providing mass storage for the system 1000. The storage device 1030 is a computer-readable medium. The storage device 1030 may be a floppy disk device, a hard disk device, an optical disk device, or a tape device. The input/output device 1040 provides input/output operations for the system 1000. The input/output device 1040 includes a keyboard and/or pointing device. The input/output device 1040 includes a display unit for displaying graphical user interfaces.

Certain aspects of the subject matter described here can be implemented as a method. An occurrence of a vugular pore system (VPS) in multiple layers of a carbonate reservoir is determined based on data collected from multiple wells in the carbonate reservoir. A spatial distribution of multiple VPS intensity classes of the VPS across the multiple layers of the carbonate reservoir is determined using at least one of well log data, borehole image log data, production log data, or seismic acoustic impedance data from the multiple wells, where each of the multiple VPS intensity classes includes a respective vugular pore size within a respective depth interval of a respective well of the multiple wells, and each of the multiple VPS intensity classes corresponds to a respective fluid flow rate of one or more fluid flow rates of the respective well. A three-dimensional (3D) VPS intensity distribution model of the VPS is constructed using the spatial distribution of the multiple VPS intensity classes of the VPS across the multiple layers of the carbonate reservoir. The 3D VPS intensity distribution model is provided for at least one of reservoir volumetric estimation, reservoir history matching, or reservoir quality prediction of the carbonate reservoir.

An aspect taken alone or combinable with any other aspect includes the following features. Multiple porosity values of each intensity class of the multiple VPS intensity classes are generated using second data from the multiple wells, where the second data include at least one of whole-core computed tomography (CT) scan data, borehole image log data, or nuclear magnetic resonance (NMR) log data from the multiple wells. A 3D VPS porosity model of the VPS is constructed using the multiple porosity values of each intensity class of the multiple VPS intensity classes.

An aspect taken alone or combinable with any other aspect includes the following features. After the 3D VPS porosity model of the VPS is constructed, the multiple porosity values of each VPS intensity class are transformed into multiple permeability values of each VPS intensity class, and a 3D VPS permeability model of the VPS is constructed using the multiple permeability values of each VPS intensity class.

An aspect taken alone or combinable with any other aspect includes the following features. Transforming the multiple porosity values of each VPS intensity class into the multiple permeability values of each VPS intensity class is based on third data from the multiple wells, where the third data include at least one of the production log data, one or more well tests, the whole-core CT scan data, or core data from the multiple wells.

An aspect taken alone or combinable with any other aspect includes the following features. Determining the spatial distribution of the multiple VPS intensity classes of the VPS using the seismic acoustic impedance data from the multiple wells includes determining the spatial distribution of the multiple VPS intensity classes of the VPS using multiple acoustic impedance values in the seismic acoustic impedance lo data, where the multiple acoustic impedance values are smaller than a predetermined value.

An aspect taken alone or combinable with any other aspect includes the following features. Multiple water saturation (Sw) to capillary pressure (Pc) functions of each VPS intensity class are generated using special core analysis (SCAL) data of vugular pore samples of the VPS and numerical Sw simulation of multiple depth intervals of the VPS. A 3D VPS Sw model is constructed using the multiple Sw to Pc functions of each VPS intensity class.

An aspect taken alone or combinable with any other aspect includes the following features. The data collected from the multiple wells for determining the occurrence of the VPS in the multiple layers of the carbonate reservoir include at least one of multiple borehole image logs, multiple caliper logs, multiple delta caliper (DCAL) logs, multiple production flow meter logs, multiple porosity logs, or core data from the multiple wells.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain implementations and generally associated methods, alterations and permutations of these implementations and methods will be apparent to those skilled in the art.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
determining an occurrence of a vugular pore system (VPS) in a plurality of layers of a carbonate reservoir based on data collected from a plurality of wells in the carbonate reservoir;
determining a spatial distribution of a plurality of VPS intensity classes of the VPS across the plurality of layers of the carbonate reservoir using at least one of well log data, borehole image log data, production log data, or seismic acoustic impedance data from the plurality of wells, wherein each of the plurality of VPS intensity classes comprises a respective vugular pore size within a respective depth interval of a respective well of the plurality of wells, and wherein each of the plurality of VPS intensity classes corresponds to a respective fluid flow rate of one or more fluid flow rates of the respective well;
constructing a three-dimensional (3D) VPS intensity distribution model of the VPS using the spatial distribution of the plurality of VPS intensity classes of the VPS across the plurality of layers of the carbonate reservoir; and
providing the 3D VPS intensity distribution model for at least one of reservoir volumetric estimation, reservoir history matching, or reservoir quality prediction of the carbonate reservoir.

2. The computer-implemented method according to claim 1, further comprising:
generating a plurality of porosity values of each intensity class of the plurality of VPS intensity classes using second data from the plurality of wells, wherein the second data comprise at least one of whole-core computed tomography (CT) scan data, the borehole image log data, or nuclear magnetic resonance (NMR) log data from the plurality of wells; and
constructing a 3D VPS porosity model of the VPS using the plurality of porosity values of each intensity class of the plurality of VPS intensity classes.

3. The computer-implemented method according to claim 2, wherein after constructing the 3D VPS porosity model of the VPS, the method further comprises:
transforming the plurality of porosity values of each VPS intensity class into a plurality of permeability values of each VPS intensity class; and
constructing a 3D VPS permeability model of the VPS using the plurality of permeability values of each VPS intensity class.

4. The computer-implemented method according to claim 3, wherein transforming the plurality of porosity values of each VPS intensity class into the plurality of permeability values of each VPS intensity class is based on third data from the plurality of wells, wherein the third data comprise at least one of the production log data, one or more well tests, the whole-core CT scan data, or core data from the plurality of wells.

5. The computer-implemented method according to claim 1, wherein determining the spatial distribution of the plurality of VPS intensity classes of the VPS using at least one of the well log data, the borehole image log data, the production log data, or the seismic acoustic impedance data from the plurality of wells comprises determining the spatial distribution of the plurality of VPS intensity classes of the VPS using a plurality of acoustic impedance values in the seismic acoustic impedance data, and wherein the plurality of acoustic impedance values are smaller than a predetermined value.

6. The computer-implemented method according to claim 1, further comprising:
generating a plurality of water saturation (Sw) to capillary pressure (Pc) functions of each VPS intensity class using special core analysis (SCAL) data of vugular pore samples of the VPS and numerical Sw simulation of a plurality of depth intervals of the VPS; and
constructing a 3D VPS Sw model using the plurality of Sw to Pc functions of each VPS intensity class.

7. The computer-implemented method according to claim 1, wherein the data collected from the plurality of wells for determining the occurrence of the VPS in the plurality of layers of the carbonate reservoir comprise at least one of the borehole image log data, caliper log data, delta caliper (DCAL) log data, production flow meter log data, porosity log data, or core data from the plurality of wells.

8. A non-transitory, computer-readable medium storing one or more instructions executable by a computer system to perform operations comprising:
determining an occurrence of a vugular pore system (VPS) in a plurality of layers of a carbonate reservoir based on data collected from a plurality of wells in the carbonate reservoir;
determining a spatial distribution of a plurality of VPS intensity classes of the VPS across the plurality of layers of the carbonate reservoir using at least one of well log data, borehole image log data, production log data, or seismic acoustic impedance data from the plurality of wells, wherein each of the plurality of VPS intensity classes comprises a respective vugular pore size within a respective depth interval of a respective well of the plurality of wells, and wherein each of the plurality of VPS intensity classes corresponds to a respective fluid flow rate of one or more fluid flow rates of the respective well;
constructing a three-dimensional (3D) VPS intensity distribution model of the VPS using the spatial distribution of the plurality of VPS intensity classes of the VPS across the plurality of layers of the carbonate reservoir; and
providing the 3D VPS intensity distribution model for at least one of reservoir volumetric estimation, reservoir history matching, or reservoir quality prediction of the carbonate reservoir.

9. The non-transitory, computer-readable medium according to claim 8, wherein the operations further comprise:
generating a plurality of porosity values of each intensity class of the plurality of VPS intensity classes using second data from the plurality of wells, wherein the second data comprise at least one of whole-core computed tomography (CT) scan data, the borehole image log data, or nuclear magnetic resonance (NMR) log data from the plurality of wells; and
constructing a 3D VPS porosity model of the VPS using the plurality of porosity values of each intensity class of the plurality of VPS intensity classes.

10. The non-transitory, computer-readable medium according to claim 9, wherein after constructing the 3D VPS porosity model of the VPS, the operations further comprise:
transforming the plurality of porosity values of each VPS intensity class into a plurality of permeability values of each VPS intensity class; and
constructing a 3D VPS permeability model of the VPS using the plurality of permeability values of each VPS intensity class.

11. The non-transitory, computer-readable medium according to claim 10, wherein transforming the plurality of porosity values of each VPS intensity class into the plurality of permeability values of each VPS intensity class is based on third data from the plurality of wells, wherein the third data comprise at least one of the production log data, one or more well tests, the whole-core CT scan data, or core data from the plurality of wells.

12. The non-transitory, computer-readable medium according to claim 8, wherein determining the spatial distribution of the plurality of VPS intensity classes of the VPS using at least one of the well log data, the borehole image log data, the production log data, or the seismic acoustic impedance data from the plurality of wells comprises determining the spatial distribution of the plurality of VPS intensity classes of the VPS using a plurality of acoustic impedance values in the seismic acoustic impedance data, and wherein the plurality of acoustic impedance values are smaller than a predetermined value.

13. The non-transitory, computer-readable medium according to claim 8, wherein the operations further comprise:
generating a plurality of water saturation (Sw) to capillary pressure (Pc) functions of each VPS intensity class using special core analysis (SCAL) data of vugular pore samples of the VPS and numerical Sw simulation of a plurality of depth intervals of the VPS; and
constructing a 3D VPS Sw model using the plurality of Sw to Pc functions of each VPS intensity class.

14. The non-transitory, computer-readable medium according to claim 8, wherein the data collected from the plurality of wells for determining the occurrence of the VPS in the plurality of layers of the carbonate reservoir comprise at least one of the borehole image log data, caliper log data, delta caliper (DCAL) log data, production flow meter log data, porosity log data, or core data from the plurality of wells.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
determining an occurrence of a vugular pore system (VPS) in a plurality of layers of a carbonate reservoir based on data collected from a plurality of wells in the carbonate reservoir;
determining a spatial distribution of a plurality of VPS intensity classes of the VPS across the plurality of layers of the carbonate reservoir using at least one of well log data, borehole image log data, production log data, or seismic acoustic impedance data from the plurality of wells, wherein each of the plurality of VPS intensity classes comprises a respective vugular pore size within a respective depth interval of a respective well of the plurality of wells, and wherein each of the plurality of VPS intensity classes corresponds to a respective fluid flow rate of one or more fluid flow rates of the respective well;
constructing a three-dimensional (3D) VPS intensity distribution model of the VPS using the spatial distribution of the plurality of VPS intensity classes of the VPS across the plurality of layers of the carbonate reservoir; and
providing the 3D VPS intensity distribution model for at least one of reservoir volumetric estimation, reservoir history matching, or reservoir quality prediction of the carbonate reservoir.

16. The computer-implemented system according to claim 15, wherein the one or more operations further comprise:
generating a plurality of porosity values of each intensity class of the plurality of VPS intensity classes using second data from the plurality of wells, wherein the second data comprise at least one of whole-core computed tomography (CT) scan data, the borehole image log data, or nuclear magnetic resonance (NMR) log data from the plurality of wells; and
constructing a 3D VPS porosity model of the VPS using the plurality of porosity values of each intensity class of the plurality of VPS intensity classes.

17. The computer-implemented system according to claim 16, wherein after constructing the 3D VPS porosity model of the VPS, the one or more operations further comprise:
transforming the plurality of porosity values of each VPS intensity class into a plurality of permeability values of each VPS intensity class; and
constructing a 3D VPS permeability model of the VPS using the plurality of permeability values of each VPS intensity class.

18. The computer-implemented system according to claim 17, wherein transforming the plurality of porosity values of each VPS intensity class into the plurality of permeability values of each VPS intensity class is based on third data from the plurality of wells, wherein the third data comprise at least one of the production log data, one or more well tests, the whole-core CT scan data, or core data from the plurality of wells.

19. The computer-implemented system according to claim 15, wherein determining the spatial distribution of the plurality of VPS intensity classes of the VPS using at least one of the well log data, the borehole image log data, the production log data, or the seismic acoustic impedance data from the plurality of wells comprises determining the spatial distribution of the plurality of VPS intensity classes of the VPS using a plurality of acoustic impedance values in the seismic acoustic impedance data, and wherein the plurality of acoustic impedance values are smaller than a predetermined value.

20. The computer-implemented system according to claim 15, wherein the one or more operations further comprise:
generating a plurality of water saturation (Sw) to capillary pressure (Pc) functions of each VPS intensity class using special core analysis (SCAL) data of vugular pore samples of the VPS and numerical Sw simulation of a plurality of depth intervals of the VPS; and
constructing a 3D VPS Sw model using the plurality of Sw to Pc functions of each VPS intensity class.
